(19) United States
(12) Patent Application Publication
(10) Pub. No.: US 2003/0189970 A1
(43) Pub. Date: Oct. 9, 2003

(54) Baking thermometer

(76) Inventor: James J. Huttner, Sylvania, OH (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/400,812

(22) Filed: Mar. 27, 2003

Related U.S. Application Data
(60) Provisional application No. 60/371,030, filed on Apr. 9, 2002.

(51) Int. Cl. G01K 1/00

(52) U.S. Cl. 374/208

(57) ABSTRACT

A thermometer having a central shaft (2) and a temperature indicator (3), is fitted with an adjustable depth gauge (1). By sliding the depth gauge (1) up or down the shaft (2), the chef can insert the device into a custard filling to a definable depth that ensures the filling temperature of the custard which is substantially in the middle of the filling is sensed, and that the device does not pierce the bottom crust (7) thereby giving a misleading temperature.

### CROSS-REFERENCE TO RELATED APPLICATION

This application claims the benefit, under 35 U.S.C. §120, of U.S. Provisional Application No. 60/371,030, entitled “Pie and Cheesecake Thermometer Provisional Patent,” filed Apr. 9, 2002, which is incorporated herein by reference.

### FIELD OF THE INVENTION

This invention relates to baking thermometers and, more particularly, to thermometers suited for baking custard filled foods.

### BACKGROUND

Custard pies and cheesecakes are common foods that use a custard filling as a base. A custard is composed of an egg and milk mixture to which is added flavorings, spices, and fillers such as pureed pumpkin or other fruits and vegetables, or whole fruits and/or vegetables in quiche, for example. The popularity of these foods has grown over the past few years, and they form a significant part of the culinary repertoire of most home chefs.

With the increased consumption of custard based foods goes the attendant risk of food borne disease. With custards, this is an especially significant problem because of the well-documented association of salmonella poisoning from eating undercooked egg products. Eggs, as they pass through the ovulatory tract of hens become contaminated with the salmonella bacterium, which is a common organism colonizing most chickens. Although the salmonella is initially on the outside of the egg, when the shell is cracked during food preparation the egg contents become contaminated. If the egg is adequately cooked, the salmonella bacteria are destroyed, and no food poisoning occurs. However, if the egg mixture is not properly cooked, salmonella bacteria may multiply in the now warm and moist custard, and cause salmonella food poisoning. The symptoms of salmonella food poisoning are primarily gastrointestinal, causing severe abdominal cramping and persistent diarrhea. The illness can range in severity from mild diarrhea to severe dehydration. Death has been known to occur as a result of severe salmonella related disease in children and immuno-compromised individuals.

Prevention of food borne illness from egg-based foods such as custards is simple—adequate cooking. The USDA recommends cooking custard-based foods to a minimum temperature of 165 degrees F. to kill salmonella and other bacteria in the egg mixture. Unfortunately, this advice is often unheeded by home chefs. The reason is simple: no good device currently exists to adequately measure the temperature of custards while they are cooking. Although food thermometers exist, these typically are not suitable for pies and cheesecakes for several reasons. First, they cannot be left in the pie or cheesecake while it cooks, because the custard mixture will not support a thermometer in the proper vertical position. Second, the pointed tip of these thermometers, excellent for piercing meat, will pierce the bottom crust of the pie or cheesecake, allowing the tip to touch the pie-pan and taking its temperature rather than that of the filling, which may give the impression of done-ness before the custard is fully cooked. As a result, to use currently available food thermometers the oven must be opened and the thermometer inserted each time the temperature is to be taken. This will cause the oven to lose heat and prolong the cooking time, and will result in an unappealing appearance of the final product due to the presence of multiple thermometer holes. Also, there is the risk of burn injury every time the oven is opened and the chef reaches in to insert the thermometer.

As a consequence, most recipes for pies and cheesecakes do not indicate that the custard is to reach a certain temperature to ensure done-ness. Instead, various suggestions are made to gauge when the pie or cheesecake is done. These include inserting a knife blade into the pie, then removing it to see if it is “clean”. (The supposition is that a custard which has “set” will not stick to the blade; in reality, the blade always looks moist with a few crumbs attached making determination of done-ness a matter of judgment rather than certainty.) Another method recommended is to “jiggle” the pan to see if the custard moves. Again, this is a very subjective test, and requires considerable experience to be able to use it reliably.

Because of this uncertainty, many home chefs tend to overcook their custard based pies and cheesecakes. Although safer from the standpoint of preventing food borne illness, overcooked custards tend to be dry and grainy, an unappealing texture. Also, they may crack and turn overly brown, again leading to an unappetizing end product.

Thus, there exists a need for providing the home chef with a simple, reliable, and easy to use method of determining when custard based foods, such as pies and cheesecakes, have reached a safe temperature.

### SUMMARY OF THE INVENTION

In accordance with a preferred embodiment of the invention, a thermometer is fitted with an adjustable depth gauge. By sliding the depth gauge up or down the shaft of the thermometer, the chef can insert the device into a custard filling to a definable depth that ensures that the filling temperature itself is sensed, and that the device does not pierce the bottom crust or tip while the custard is baking.

### BRIEF DESCRIPTION OF THE DRAWINGS

FIG. 1 is a side view of a preferred embodiment of the invention;

FIG. 2 is an isometric view of a preferred embodiment of the invention;

FIG. 3 is an isometric view of a preferred embodiment of the invention with an adjustable depth gauge separated from the shaft of the thermometer;

FIG. 4 is a side cut-away view of a preferred embodiment of the invention after insertion into a custard based food; and

FIG. 5 is a side cut-away view of the device and custard based food shown in FIG. 4 after baking.

### DETAILED DESCRIPTION OF THE INVENTION

A preferred embodiment of the invention utilizes a pop-up type thermometer. Although pop-up thermometers of this type are known in the art and are in current use for meats and poultry, the addition of a novel adjustable depth gauge allows the thermometer to be used reliably with custard based foods, such as pies and cheesecakes. Pop-up thermometers generally consist of an outer case, a plunger/indicator, a spring and a fusible metal alloy similar to solder. The fusible metal alloy is solid at room temperatures and is selected to melt at a pre-determined temperature (which, in the case of the pie custards is preferably approximately 165 degrees F.). The fusible metal alloy holds the plunger in the down position at room temperatures. The spring is biased against the plunger. When the metal alloy turns to liquid, it releases the plunger and the spring pushes the plunger up to the “popped” position. Pop-up thermometers of this type are generally reliable within 2 degrees of their specified temperature and may be reused by melting the metal alloy in hot water and setting the plunger in the down position as the alloy cools. Thus, with the novel device of the present invention, the home chef can be reliably assured of reaching proper cooking temperatures for all custard based pies and cheesecakes.

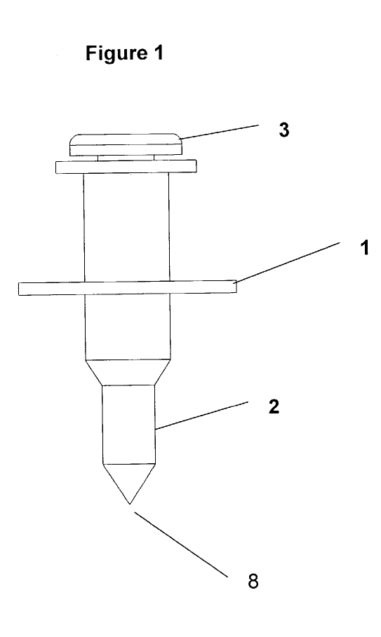

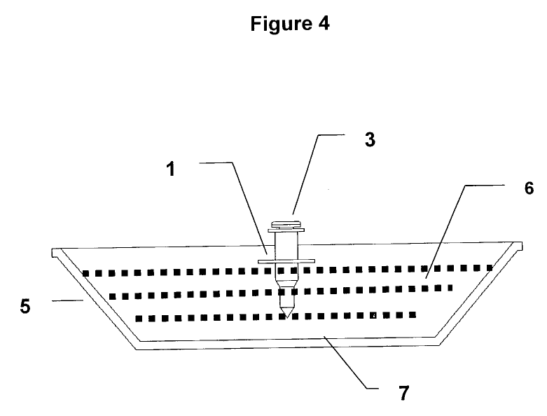

With reference to FIGS. 1-5 a preferred embodiment of the invention is discussed. FIG. 1 shows a side view of a preferred embodiment of the invention. An adjustable depth gauge (1) is shown snugly fitted to the central shaft (2) of the thermometer. The shaft is preferably cylindrical and devoid of any barbs or stubs that might serve to engage the custard filling and cause tear. The plunger/indicator (3) of the thermometer is shown in the closed position. In the preferred embodiment of the invention, the distal tip (8) of the thermometer is substantially blunted, instead of pointed, so that it becomes less likely to pierce the bottom crust (see (7) in FIG. 4) of a pie or cake.

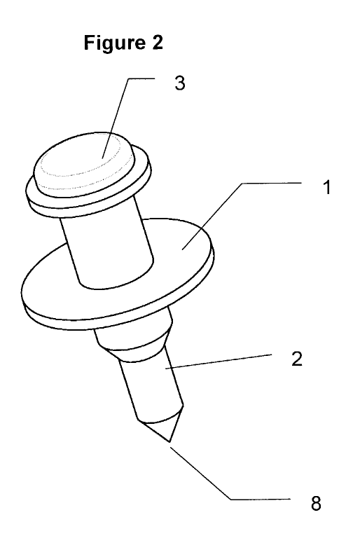

FIG. 2 shows an isometric view of the thermometer of FIG. 1. Again, the adjustable depth gauge (1) is shown snugly fitted to the central shaft (2) of the thermometer. The plunger/indicator (3) is again shown in the closed position.

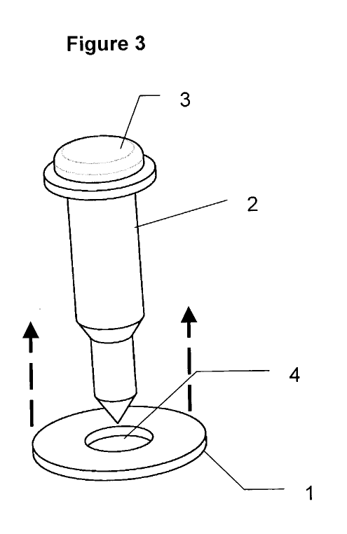

FIG. 3 shows an isometric side view of the thermometer of FIG. 1 with the adjustable depth gauge (1) separated from the shaft (2) of the thermometer. The center hole (4) of the depth gauge (1) is shown, with arrows indicating how it is placed on the pie and cheesecake thermometer. The adjustable depth gauge (1) is preferably shaped like a ring or washer and is preferably sufficiently wide and buoyant in the medium of a custard filling to allow the thermometer to be inserted without tipping under normal handling conditions while preparing the food. The gauge (1) may alternatively be shaped in any configuration (e.g. a cross pattern) which allows the gauge (1) to stabilize the device which in the medium of a custard. The depth gauge (1) preferably has a central hole that fits snugly to the shaft of the thermometer such that the depth gauge (1) may be slide-ably positioned higher or lower on the shaft of the thermometer as dictated by the depth of the custard based food. In alternate embodiments, the gauge (1) may be permanently fixed to the shaft (2). The depth gauge (1) is preferably made of a food safe, temperature stable, polymeric material such as Teflon™.

FIG. 4 shows a side cut-away view of the pie and cheesecake thermometer as it would sit after insertion into the filling of a custard based food, such as a pie or cheesecake (5). The thermometer has been inserted into the filing until the gauge (1) sits on the top crust of the custard filing. The depth gauge (1) has been adjusted so that the thermometer is positioned substantially in the middle of the custard filling (6). This is significant because it its important to measure the coolest portion of the custard in order to avoid salmonella contamination. Note that the distal tip of the pie and cheesecake thermometer preferably does not touch or pierce the bottom crust (7) of the pie. The plunger/indicator (3) is shown in the closed position, as it would be before baking.

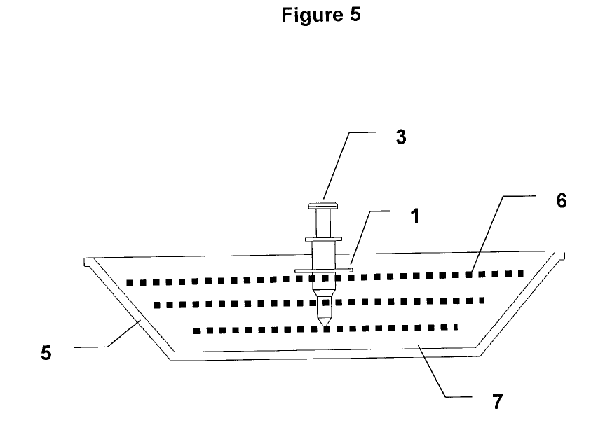

FIG. 5 shows the same view as FIG. 4 after baking. The custard filling has reached the proper temperature to ensure that it is adequately cooked, and the plunger/indicator has “popped-up” to its open position to indicate done-ness. Callout references are the same as indicated in FIG. 5.

Although the specification and illustrations of the invention contain many particulars, these should not be construed as limiting the scope of the invention but as merely providing an illustration of the preferred embodiments of the invention. For example, alternate styles of thermometers (such as digital, mercury or non-reusable pop-up style thermometers) may be utilized. In yet another embodiment, the temperature indicator might be an audible alarm, similar to that taught in U.S. Pat. No. 6,230,649, instead of a visual indicator. Thus, the claims should be construed as encompassing all features of patentable novelty that reside in the present invention, including all features that would be treated as equivalents by those skilled in the art.

What is claimed is:

1. A temperature monitor comprising:
a thermometer having a center shaft, a temperature indicator and a distal tip; and
a depth gauge adapted to be adjustably positioned along said center shaft.

2. The temperature monitor of claim 1 wherein said depth gauge comprises a ring having a central circular hole fitting snugly to said center shaft.

3. The temperature monitor of claim 1 wherein said depth gauge is comprised of a food safe, temperature stable material.

4. The temperature monitor of claim 3 wherein said depth gauge is Teflon™.

5. The temperature monitor of claim 1 wherein said thermometer is a pop-up style thermometer comprising a fusible metal alloy, said temperature indicator comprising a plunger.

6. The temperature monitor of claim 5 wherein said fusible metal alloy is selected to melt at a temperature adequate to safely cook a custard based filling.

7. The temperature monitor of claim 5 wherein said fusible metal alloy is selected to melt at approximately 165 degrees F.

8. The temperature monitor of claim 1 wherein said distal tip is substantially blunted.

9. The temperature monitor of claim 1 wherein said depth gauge comprises a polymeric material that is buoyant in the medium of a custard filling.

10. The temperature monitor of claim two wherein said center shaft is cylindrical.

11. A temperature monitor for baking foods containing a custard filing comprising:
a thermometer having a center shaft, a temperature indicator and a distal tip; and
a stabilizing member positioned along said center shaft to stabilize said thermometer in the medium of said custard filling.

12. The temperature monitor of claim 11 wherein said stabilizing member is permanently fixed to said shaft.

13. The temperature monitor of claim 11 wherein said stabilizing member is adjustably positioned along said shaft.

14. The temperature monitor of claim 13 wherein said stabilizing member is slidably positioned along said shaft.

15. The temperature monitor of claim 14 wherein said stabilizing member is in the shape of a ring.

16. A method using a thermometer for baking a custard based pie having a bottom crust and a top crust, said thermometer having a central shaft and a distal tip, said method comprising:
positioning a depth gauge along said central shaft; and
inserting said central shaft into said pie until said depth gauge reaches said top crust,
said depth gauge being positioned along said shaft such that said distal tip of said thermometer is substantially in the middle of said pie.
